(19) United States
(12) Patent Application Publication
(10) Pub. No.: US 2020/0087199 A1
(43) Pub. Date: Mar. 19, 2020

(54) MATERIAL AND PROCESS TO CREATE COMPOSITE LAYERS, EMBEDDED FEATURES OR ARMOR

(71) Applicant: CORNING RESEARCH & DEVELOPMENT CORPORATION, Corning, NY (US)

(72) Inventor: Michael John Gimblet, Conover, NC (US)

(21) Appl. No.: 16/686,282

(22) Filed: Nov. 18, 2019

Related U.S. Application Data
(63) Continuation of application No. PCT/US18/34676, filed on May 25, 2018.
(60) Provisional application No. 62/513,029, filed on May 31, 2017.

(51) Int. Cl. C03C 25/143; C03C 25/105; C03C 25/1065; G02B 6/44

(52) U.S. Cl. CPC C03C 25/143; C03C 25/105; C03C 25/1065; C03C 2217/78; G02B 6/448; G02B 6/4486; C03C 2218/112; G02B 6/443

(57) ABSTRACT

Embodiments of a method of applying a coating to an optical fiber cable core are provided. The cable core includes a plurality of optical fibers arranged in one or more buffer tubes. The method includes the step of continuously running a length of the cable core past at least one spraying station on a process line. The method also includes the step of spraying at least a portion of the cable core with at least one material. The at least one material includes one or more components that cure to form an elastomer, and the at least one material forms a jacket surrounding the cable core. Additionally, embodiments of an optical fiber cable having a spray-on coating are provided.

### PRIORITY APPLICATIONS

This application is a continuation of International Application No. PCT/US18/34676, filed on May 25, 2018, which claims the benefit of priority to U.S. application Ser. No. 62/513,029, filed on May 31, 2017, both applications being incorporated herein by reference.

### BACKGROUND

The disclosure relates generally to cables and more particularly to optical fiber cables having a spray-on cable jacket of one or more materials. Optical cables have seen increased use in a wide variety of field's including various electronics and telecommunications fields. Optical cables contain or surround one or more optical fibers. The cable provides structure and protection for the optical fibers within the cable.

### SUMMARY

In one aspect, embodiments of a method of applying a coating to an optical fiber cable core are provided. The cable core includes a plurality of optical fibers arranged in one or more buffer tubes. The method includes the step of continuously running a length of the cable core past at least one spraying station on a process line. The method also includes the step of spraying at least a portion of the cable core with at least one material. The at least one material including one or more components that cure to form an elastomer, and the at least one material forms a jacket surrounding the cable core.

In another aspect, embodiments of a method of forming an optical fiber cable are provided. The method includes the step of moving a length of cable core past a spraying station. The cable core includes a plurality of optical fibers. The method also includes the step of spraying an elastomeric material onto the cable core as the cable core passes the spraying station and forming a contiguous elastomeric layer surrounding the cable core in the circumferential direction and extending the length of the cable core.

In still another aspect, embodiments of an optical fiber cable are provided. The optical fiber cable includes a cable core that includes a plurality of optical fibers and one or more buffer tubes into which the plurality of optical fibers are arranged. The optical fiber cable also includes a spray-on coating that surrounds at least a portion of the cable core, and the spray-on coating is made of an elastomeric material.

Additional features and advantages will be set forth in the detailed description that follows, and in part will be readily apparent to those skilled in the art from the description or recognized by practicing the embodiments as described in the written description and claims hereof, as well as the appended drawings.

It is to be understood that both the foregoing general description and the following detailed description are merely exemplary, and are intended to provide an overview or framework to understand the nature and character of the claims.

The accompanying drawings are included to provide a further understanding and are incorporated in and constitute a part of this specification. The drawings illustrate one or more embodiment(s), and together with the description serve to explain principles and the operation of the various embodiments.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is an isometric view of an optical fiber cable having a spray-on jacket, according to an exemplary embodiment;

FIG. 2 depicts two sprayers spraying a jacket on an optical fiber cable core, according to an exemplary embodiment;

FIGS. 3A-3E depict a variety of spray patterns for applying the spray-on jacket to the optical fiber cable core, according to exemplary embodiments;

FIGS. 4A-4B depict a spray-on jacket including multiple materials in layers (FIG. 4A) and in alternating sections (FIG. 4B), according to exemplary embodiments; and

FIG. 5 depicts a cable strand branching from the cable and that is held to the cable using a thin spray-on membrane, according to an exemplary embodiment.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION

Referring generally to the figures, various embodiments of an optical fiber cable with a spray-on jacket (e.g., a jacket formed via a spray-applied polymer material, a spray-applied elastomeric material, etc.) and of a method of spraying on an optical cable fiber jacket are provided. In embodiments, spraying on the jacket allows for the application of multiple different materials to form a composite material having customized properties. Advantageously, in at least some embodiments, the spray-on jacket does not experience jacket shrinkage that is inherent to other jacket formation techniques (e.g., jacket extrusion), and the spray-on jacket enhances control over excess fiber length creation. Moreover, in at least some embodiments, spraying on the jacket does not require implementation and maintenance of expensive tooling (e.g., screw extruder and barrel design) or the use of high temperatures. In certain embodiments, the spray-on jacket includes an elastomeric material, which creates a dielectric armor capable of providing ballistic protection.

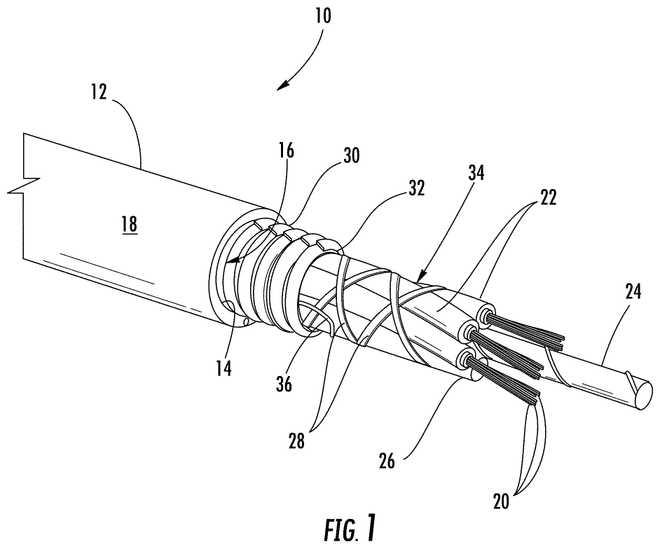

As shown in FIG. 1, an optical cable, shown as cable 10, is illustrated according to an exemplary embodiment. Cable 10 includes an outer cable jacket, shown as outer spray-on jacket 12, having an inner surface 14 that defines an inner passage or cavity, shown as central bore 16, and an outer surface 18 that generally defines the outermost surface of cable 10. As will be generally understood, inner surface 14 of spray-on jacket 12 defines an internal area or region within which the various cable components discussed herein are located.

Cable 10 includes one or more optical transmission elements or optical waveguides, shown as optical fibers 20. In the embodiment shown, groups of optical fibers 20 are located in separate buffer tubes 22, and buffer tubes 22 are wrapped (e.g., in an SZ stranding pattern) around a central strength member 24. In various embodiments, cable 10 includes at least four buffer tubes 22 (although only tree buffer tubes 22 can be seen in FIG. 1). Central strength member 24 may be any suitable axial strength member, such as a glass-reinforced plastic rod, steel rod/wire, etc. As is also shown in FIG. 1, one or more additional core elements, shown as filler rods 26, may also be included in the cable 10. Further, in embodiments, helically wound binders 28 are wrapped around buffer tubes 22 and filler rods 26 to hold these elements in position around central strength member 24.

Generally, cable 10 provides structure and protection to optical fibers 20 during and after installation (e.g., protection during handling, protection from elements, protection from the environment, protection from vermin, etc.). In various embodiments, cable 10 also includes an armor layer, shown as armor 30. In general, armor 30 is formed from a strip of metal material (e.g., a metal tape, a flat elongate continuous piece of material, etc.) that is wrapped around and circumferentially surrounds buffer tubes 22. As shown in FIG. 1, armor 30 is located adjacent to the inner surface 14 of the spray-on jacket 12 such that these two layers are in contact with each other.

In specific embodiments, armor 30 is corrugated steel tape material that is wrapped around the interior portions of cable 10, and in some of these embodiments, armor 30 is longitudinally folded forming a longitudinal overlapped section 32 where opposing edges of the tape overlap to completely surround inner buffer tubes 22 (and any other interior component of cable 10). In other embodiments, armor 30 may be a strip of metal tape material, helically wrapped around buffer tubes 22 such that armor 30 forms a layer circumferentially surrounding buffer tubes 22. In general, armor layer 30 provides an additional layer of protection to optical fibers 20 within cable 10, and may provide resistance against damage (e.g., damage caused by contact or compression during installation, damage from the elements, damage from rodents, etc.). Cable 10 may also include a variety of other components or layers, such as water absorbent layers or powders, circumferential constrictive thin-film binders, etc. The combination of such components as well as the buffer tubes 22, filler rods 26, central strength member 24, binder 28, and armor 30 (if included) are referred to generally as cable core 34. Additionally, in other embodiments, the optical fibers are arranged in stacks of ribbons, and the stacks are contained in one or more buffer tubes so as to provide an optical fiber ribbon cable.

Returning to the embodiment shown in FIG. 1, cable 10 includes one or more preferential tear feature and/or ripcord 36 embedded in or underneath the spray-on jacket 12. In this embodiment, the preferential tear feature and/or ripcord 36 is located within armor 30 such that ripcord 28 facilitates opening of the armor 30 and the spray-on jacket 12. In some embodiments, ripcord 36 may be located only within the spray-on jacket 12 so as to only open the spray-on jacket 12.

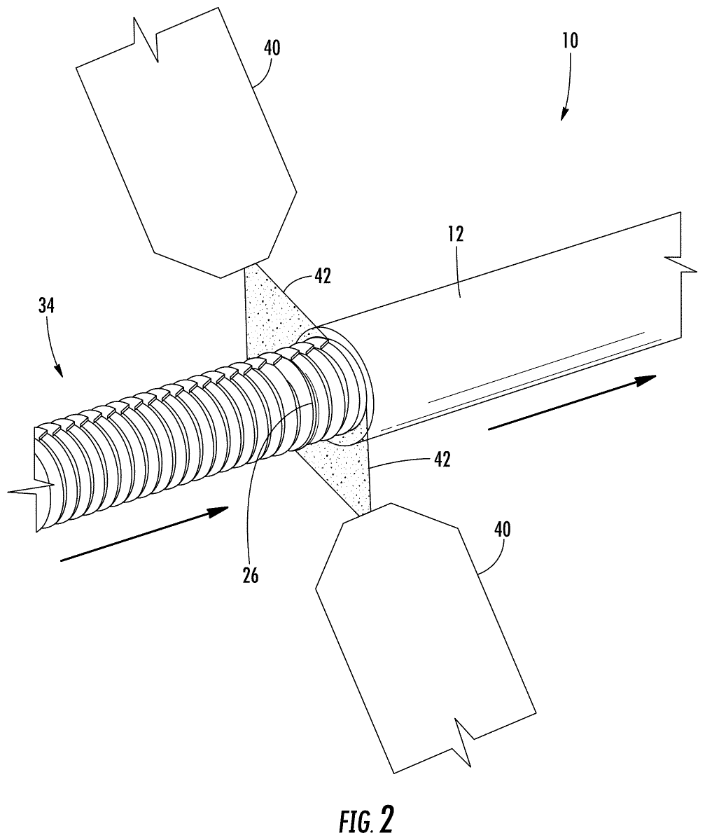

As shown in FIG. 2, the spray-on jacket 12 is applied to the cable core 34. In an embodiment, the process of spraying the spray-on jacket 12 on the cable core 34 is continuous, i.e., the cable core 34 is conveyed past spray nozzles 40 where a cone 42 of spray-on material is applied to the cable core 34. However, in other embodiments, the cable core 34 is stationary, and the spray nozzles 40 are moved along a section of the cable core 34. As shown in the exemplary embodiment of FIG. 2, a spraying station with two spray nozzles 40 is provided to apply the spray-on jacket 12; however, in other embodiments, a single spray nozzle 40 or more than two spray nozzles 40 are provided at a single spraying station. For example, the process line can include sets of spay nozzles 40 arranged in a series of spraying stations to apply a thicker coating or a different material.

A variety of materials can be applied to the cable core 30 to form the spray-on jacket 12. In general, the materials that form the spray-on jacket 12 are stored as one or more liquids. When heated, reacted, and/or sprayed onto the cable core 34, the liquid begins to solidify to form the spray-on jacket 12. In an exemplary embodiment, the spray-on jacket 12 is an elastomeric material. In a particular embodiment, the elastomeric material is a combination of polyurethane and polyurea (e.g., LINE-X® or PAXCON® by Line-X LLC, Huntsville, Ala.). In such an embodiment, the elastomeric coating of polyurethane and polyurea can be applied by spraying a two component stream onto the cable core 34. For example, a first stream of polyfunctional aromatic and/or aliphatic isocyanates and a second stream of polyetheamines and/or polyols (and optionally including amine chain extenders) can be sprayed through a high -pressure (e.g., 1400-2500 psi) spray nozzle at a temperature of, e.g., 150-160° F. Upon contacting the cable core 34, the components of the two streams will react and cure (i.e., solidify) in approximately 3-5 seconds. Advantageously, the polyurethane and polyurea offer mechanical toughness above other non-spray-on materials, provide a dielectric armor, enhance ballistics protection, and in some embodiments, may provide rodent protection. Further, because of the relatively quick cure time, thick layers of polyurethane and polyurea coating can be built up over successive passes.

Other suitable materials that can be used alone or in combination with the elastomeric material in the spray-on jacket include urethanes, silicones, metal/alloy sprays, etc. In addition, the material of the spray-on jacket 12 may include small quantities of other materials or fillers that provide different properties to the material of the spray-on jacket 12. For example, the material of the spray-on jacket 12 may include materials that provide for coloring, UV/light blocking (e.g., carbon black), flame retardance, etc.

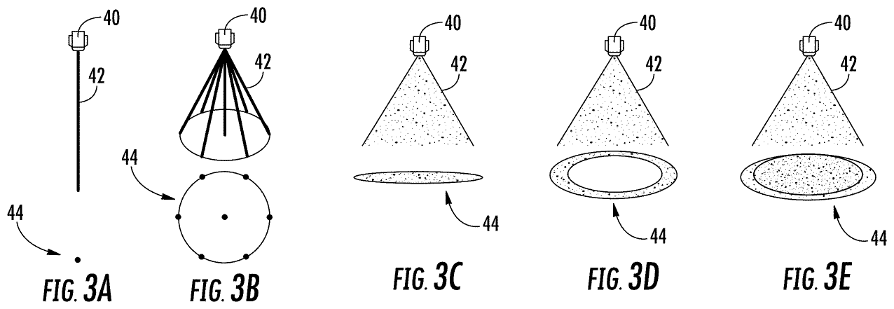

Moreover, the spray-on materials can be applied using spray nozzles 40 having a variety of spray cones 42 to achieve different effects. In the embodiment shown in FIG. 3A, the spray nozzle 40 applies a cone 42 in the shape of a jet. The spray pattern 44 is essentially a point. In embodiments, this spray pattern 44 is used to apply a strip of spray-on material. In the embodiment shown in FIG. 3B, the spray nozzle 40 applies a cone 42 in the shape of multiple jets. The spray pattern 44 corresponds to points around a circle with one point in the center of the circle. In embodiments, this spray pattern 44 is used to apply multiple strips of spray-on material in which a certain strip or strips have more material applied than the other strips. This spray pattern 44 could be used, for example, to provide preferential tear regions in the coating. In the embodiment shown in FIG. 3C, the nozzle 40 applies a flat cone 42 having essentially a straight line spray pattern 44. In embodiments, this spray pattern 44 is used to apply a relatively thick spray-on coating. In the embodiment shown in FIG. 3D, the nozzle 40 applies a hollow cone 42 having essentially a ring spray pattern 44. In embodiments, this spray pattern 44 can be pulsed to apply transverse strips of spray-on coating (i.e., transverse to the longitudinal axis of the cable core 30 as shown in FIG. 2). In the embodiment shown in FIG. 3E, the nozzle 40 applies a full cone 42 having essentially a circular spray pattern 44. In embodiments, this spray pattern 44 is used to apply a relatively thin spray-on coating (as compared to the flat cone 42 of FIG. 3C).

Further, as discussed above, a process line can include multiple nozzles 40, including, for example, multiple nozzles 40 at a single spraying station, multiple nozzles 40 arranged in series of spraying stations, and multiple nozzles 40 at each of a plurality of spraying stations arranged in series. Additionally, the type of nozzle 40 at each spraying station can be any of the exemplary nozzles 40 depicted in FIGS. 3A-3E. Thus, for example, one or more longitudinal strips can be applied using the nozzle 40 in FIG. 3A at a first spraying station followed by a complete circumferential coating using, e.g., two flat cone 42 nozzles 40 shown in FIG. 3C. In this way, a series of nozzles 40 or spraying stations are able to build a desired cable layer or feature.

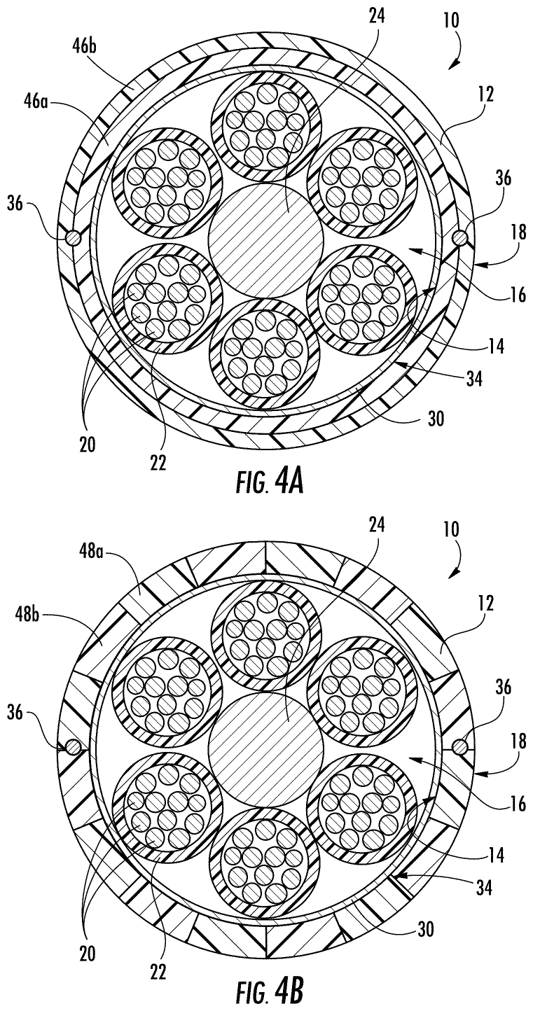

For example, in embodiments, the nozzles 40 can be used to build up multiple layers 46a, 46b of materials in the spray-on jacket 12 as shown in FIG. 4A. The embodiment depicted in FIG. 4A corresponds to a section of cable 10 in which a first layer 46a was sprayed onto the cable core 34 outside of the armor 30. After application of the first layer 46a, a second layer 46b was applied to form the completed spray-on jacket 12. The first layer 46a and second layer 46b can be the same or different materials, i.e., multiple layers of the same material to build up thickness or different materials to provide a combination of properties. In a particular embodiment, at least one of first layer 46a or second layer 46b is an elastomeric material, such as a polyurethane/polyurea mixture. Further, while only two layers 46a, 46b are shown, the spray-on jacket 12 is comprised of more than two layers in other embodiments. In certain embodiments with more than two layers, at least one layer is an elastomeric material, such as a polyurethane/polyurea mixture.

FIG. 4B depicts another embodiment in which the spray-on jacket 12 includes alternating longitudinal sections 48a, 48b. That is, FIG. 4B depicts a first section 48a and a second section 48b that are applied as longitudinal strips (i.e., strips running along the length of the cable core 30). The first section 48a and second section 48b alternate around the circumference of the cable core 30. FIG. 4B depicts sixteen relatively thin sections 48a, 48b, but in other embodiments, more or fewer sections 48a, 48b are used. For example, in an embodiment, the spray-on cable jacket 12 includes only one first section 48a and only one second section 48b in which each section 48a, 48b extends around approximately half the circumference of the cable core 30.

Additionally, while the first layer 46a and the second layer 46b are shown in a single embodiment (FIG. 4A) and while the first section 48a and the second section 48b are also shown in a single embodiment (FIG. 4B), an embodiment features both layers 46a, 46b and sections 48a, 48b. For example, in an embodiment, the cable 10 has a spray-on jacket 12 with a first layer 46a that includes sections 48a, 48b. On top of the sectioned first layer 46a, the second layer 46b is applied. In still another embodiment, the first layer 46a is a single material on top of which a sectioned, second layer 46b is applied. In still another embodiment, both layers 46a, 46b include alternating sections 48a, 48b of longitudinal strips. In a particular embodiment, the sections 48a, 48b on the first layer 46a are different in width than the sections 48a, 48b on the second layer such that the interface between adjacent sections 48a, 48b is overlapped by a section 48a, 48b in another layer 46a, 46b.

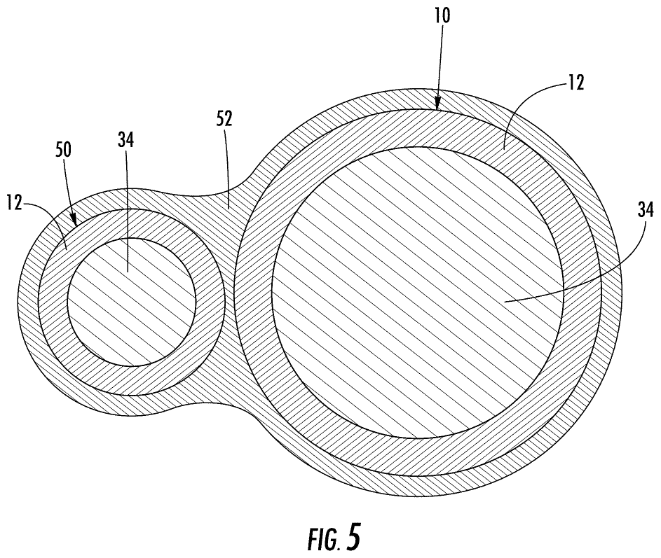

Further, in embodiments, the spray-on jacket 12 is used to slightly bond finished cable elements for breakout at a later desired time by the end user. For example, in the embodiment illustrated in FIG. 5, the cable 10 includes a strand 50, e.g., a tether or drop cable, that branches from the main cable 10 body. A cable 10 can include multiple such strands 50 that branch at various points along the installation path. Using the above-described spraying technique, a light coating of spray-on material can be applied to the strands 50 and cable 10 to create a webbing or thin membrane 52 that holds the strand 50 to the main body of the cable 10. As can be seen in FIG. 5, the strand 50 and the cable 10 both have a spray-on jacket 12 surrounding their respective cable cores 34 (shown schematically). Thus, the membrane 52 can be applied to the spray-on jacket 12, or in other embodiments, the membrane 52 can be applied directly to the cable cores 34 of the strand 50 and cable 10. By slightly bonding these elements to the cable body, the entire cable can be stored, transported, and unfurled more easily. Then, during installation, the strands can be more easily broken away from the main cable body by tearing through the thin webbing or membrane.

Advantageously, the spray-on process allows for custom composite cables. That is, the cable can include a customized jacket for a variety of different installation environments and having a variety of different properties. Also advantageously, spraying on the cable jacket avoids the need for the cable core to undergo an extrusion or pultrusion process for application of the cable jacket. Such extruded or pultruded cable jackets can, in some circumstances, experience shrinkage after processing as a result of cooling and/or residual stresses in the cable jacket. Further, such extrusion and pultrusion processes can, in some circumstances, require precision tooling that is expensive to implement and maintain, and these processes can present challenges with respect to safety and energy consumption because the processing materials are kept at elevated temperatures. Additionally, extrusion performed at high speeds can exacerbate shrinkage and increase drag in the cooling water trough. By spraying the jacket onto the cable core, the cable made according to embodiments of the present disclosure avoid these and other issues while beneficially providing a dielectric armor with ballistic protection and enhanced excess fiber length control.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that any particular order be inferred. In addition, as used herein, the article “a” is intended to include one or more than one component or element, and is not intended to be construed as meaning only one.

It will be apparent to those skilled in the art that various modifications and variations can be made without departing from the spirit or scope of the disclosed embodiments. Since modifications, combinations, sub-combinations and variations of the disclosed embodiments incorporating the spirit and substance of the embodiments may occur to persons skilled in the art, the disclosed embodiments should be construed to include everything within the scope of the appended claims and their equivalents.

What is claimed is:

1. A method of applying a coating to an optical fiber cable core, the cable core comprising a plurality of optical fibers arranged in one or more buffer tubes, the method comprising the steps of:
continuously running a length of the cable core past at least one spraying station on a process line; and
spraying at least a portion of the cable core with at least one material, wherein the at least one material comprises one or more components that cure to form an elastomer and wherein the at least one material forms a jacket surrounding the cable core.

2. The method of claim 1, wherein the method does not comprise a step of extruding a coating around the cable core or a step of running the cable core through a water trough.

3. The method of claim 1, further comprising including a mixture of polyurethane and polyurea in the elastomer.

4. The method of claim 1, wherein the process line includes at least a first spraying station and a second spraying station arranged in series, and wherein the method further comprises the steps of:
spraying at least a portion of the cable core with a first material at the first spraying station; and
spraying at least a portion of the cable core with a second material at the second spraying station;
wherein the first material and the second material are different; and
wherein the first material or the second material forms the elastomer.

5. The method of claim 1, wherein the process line includes at least a first nozzle and a second nozzle at the at least one spraying station, and wherein the method further comprises the steps of:
spraying a first material from the first nozzle in a first strip along the length of the cable core; and
spraying a second material from the second nozzle in a second strip along the length of the cable core;
wherein the first material and the second material are different; and
wherein the first material or the second material forms the elastomer.

6. The method of claim 1, wherein the cable core is surrounded by an armor layer, and wherein the step spraying at least a portion of the cable core with at least one material further comprises:
spraying an outer surface of the armor layer so as to form a spray-on cable jacket around the armor layer.

7. The method of claim 1, wherein one or more strands branches from the cable core, wherein each of the one or more strands includes at least one optical fiber, and wherein the method further comprises the step of:
spraying a membrane on the strands to bind the strands to the cable core.

8. The method of claim 1, wherein spraying at least a portion of the cable core with at least one material further comprises forming at least one layer of solidified polymer material surrounding the cable core.

9. A method of forming an optical fiber cable comprising:
moving a length of cable core past a spraying station, wherein the cable core comprises a plurality of optical fibers;
spraying an elastomeric material onto the cable core as the cable core passes the spraying station; and
forming a contiguous elastomeric layer surrounding the cable core in the circumferential direction and extending the length of the cable core.

10. The method of claim 9, wherein the contiguous polymer layer formed from the sprayed elastomeric material defines the outermost surface of the optical fiber cable.

11. An optical fiber cable, comprising:
a cable core, comprising:
a plurality of optical fibers; and
one or more buffer tubes, wherein the plurality of optical fibers are arranged in the one or more buffer tubes; and
a spray-on coating that surrounds at least a portion of the cable core, wherein the spray-on coating is comprised of an elastomeric material.

12. The optical fiber cable of claim 11, wherein the spray-on coating comprises at least two layers, and wherein at least one layer but less than all of the at least two layers is an elastomeric material.

13. The optical fiber cable of claim 12, wherein at least one of the at least two layers completely surrounds the cable core.

14. The optical fiber cable of claim 12, wherein the elastomeric material in at least one layer is comprised of a mixture of polyurethane/polyurea.

15. The optical fiber cable of claim 12, wherein the spray-on coating completely surrounds the cable core so as to form a cable jacket around the cable core.

16. The optical fiber cable of claim 11, wherein the cable core further comprises an armor layer surrounding the one or more buffer tubes and wherein the spray-on coating is sprayed onto the armor layer.

17. The optical fiber of claim 11, wherein the elastomeric material comprises a mixture of polyurethane and polyurea.

18. The optical fiber of claim 11, wherein the spray-on coating comprises at least two materials that are applied as at least two strips along a length of the cable.

19. The optical fiber of claim 11, wherein the plurality of optical fibers are arranged in stacks of ribbons such that the optical fiber cable is an optical fiber ribbon cable.

20. The optical fiber of claim 11, further comprising a strand of one or more optical fibers that branch from the cable core, wherein the strand is held to the spray-on jacket with a spray-on membrane.
